(19) United States
(12) Patent Application Publication
(10) Pub. No.: US 2016/0221047 A1
(43) Pub. Date: Aug. 4, 2016

(54) METHOD FOR CLEANING SUBSTRATE HAVING ORIENTATED FILM FORMED THEREON

(71) Applicants: BOE TECHNOLOGY GROUP CO., LTD., Beijing (CN); BEIJING BOE OPTOELECTRONICS TECHNOLOGY CO., LTD, Beijing (CN)

(72) Inventors: Jian Li, Beijing (CN); Yuguang Fan, Beijing (CN); Yongshan Zhou, Beijing (CN)

(21) Appl. No.: 14/743,574

(22) Filed: Jun. 18, 2015

(30) Foreign Application Priority Data
Feb. 4, 2015 (CN) 201510058837.6

(51) Int. Cl. B08B 3/12; G02F 1/1337

(52) U.S. Cl. CPC B08B 3/12; G02F 1/133784; G02F 1/133711

(57) ABSTRACT

This disclosure provides a method for cleaning a substrate having an orientated film formed thereon and relates to the technical field of display. By using this cleaning method, the orientation abnormality due to the residue of a rayon rubbing cloth on the orientated film is greatly improved, and the occurrence probability of white Mura on a display panel is reduced. The method for cleaning a substrate having an orientated film formed thereon comprises the steps of subjecting the orientated film to a cooling treatment so that the temperature of the orientated film is lowered by 10° C. to 30° C. in a time period ranging from 10 s to 40 s; and cleaning the orientated film after the cooling treatment. This method is useful for cleaning a substrate having an orientated film formed thereon.

### TECHNICAL FIELD

This disclosure relates to the technical field of display, and specifically, to a method for cleaning a substrate having an orientated film formed thereon.

### BACKGROUND

Due to the features of small size, low power consumption, no radiation as well as relatively low production cost or the like, LCD (Liquid Crystal Display) has taken the main role in the technical field of display.

LCD comprises an array substrate and a color film substrate which are box-aligned. Generally, a liquid crystal layer is provided between the array substrate and the color film substrate, and by controlling the deflection of the liquid crystal molecules in the liquid crystal layer, the light transmissivity is controlled so as to achieve the image displaying of different gray scales.

In order to make the primary alignment of the liquid crystals consistent so that the deflection of the liquid crystal molecules is effectively controlled subsequently, it is generally demanded to provide orientated films on a side of the array substrate close to the liquid crystal layer and on a side of the color film substrate close to the liquid crystal layer, respectively, before box-aligning the array substrate and the color film substrate. In general, the preparation of an orientated film comprises the following two steps: firstly, a transparent resin layer is formed on a surface of the array substrate or the color film substrate; and then, the transparent resin layer is rubbed by using a rubbing cloth to form ordered texture and thus, an orientated film is formed. The rubbing cloth used in the above process is mainly divided into a cotton fiber rubbing cloth and a rayon rubbing cloth. Because the price of the rayon rubbing cloth is cheaper than that of the cotton fiber rubbing cloth, the rayon rubbing cloth is used more frequently.

During the process for forming rayon, a layer of synthetic resin is commonly coated on the surface of the fiber molecules. Because the synthetic resin generally has a smaller molecular weight, this synthetic resin is easily inclined to fall off when the rayon rubbing cloth is used to rub the surface of the array substrate or the color film substrate. Furthermore, in the subsequent cleaning process, the fell rayons are generally difficult to be removed completely due to improper cleaning manner. The rayons which are not removed by cleaning remain on the array substrate and/or the color film substrate, which causes damage and pollution to the orientated film so that the orientation of the orientated film is abnormal. In the display panel formed after box-aligning such array substrate and color film substrate, waterlogging spots (that is, white Mura) are easily inclined to exist in the display frame, and thus, the displaying effect thereof is deteriorated.

### SUMMARY

The embodiments of the disclosure provide a method for cleaning a substrate having an orientated film formed thereon. By using this cleaning method, the orientation abnormality due to the residue of a rayon rubbing cloth on the orientated film is greatly improved, and the occurrence probability of white Mura on a display panel is reduced.

In order to achieve the above object, the embodiments of the disclosure make use of the following technical solution:

The embodiments of the disclosure provide a method for cleaning a substrate having an orientated film formed thereon, comprising the steps of subjecting the orientated film to a cooling treatment so that the temperature of the orientated film is lowered by 10° C. to 30° C. in a time period ranging from 10 s to 40 s; and cleaning the orientated film after the cooling treatment.

According to the method for cleaning a substrate having an orientated film formed thereon provided in the embodiments of the disclosure, the temperature of the orientated film is lowered suddenly by 10° C. to 30° C. through the cooling treatment in a short time. The polarity and hardness of the rayon rubbing cloth remained on the orientated film and the polarity and hardness of the orientated film will be changed along with the sudden lowering of the temperature. Because the material for forming the rayon rubbing cloth is different from that of the orientated film, the changing rates of the polarity and hardness of the both along with the lowering of the temperature are different, and thus, the adhesion between the rayon rubbing cloth and the orientated film is reduced. Especially, when the difference between the changing rates of the polarity and hardness of the rayon rubbing cloth and that of the orientated film is prominent, the adhesion between the rayon rubbing cloth and the orientated film will be further reduced. Next, when the orientated film after the cooling treatment is further cleaned, the residual rayon rubbing cloth may be easily and completely removed, and thus, the orientation abnormality due to the residue of a rayon rubbing cloth on the orientated film is improved to the most extent, and furthermore, the occurrence probability of white Mura on a display panel is reduced.

### BRIEF DESCRIPTION OF THE DRAWINGS

In order to more clearly demonstrate the technical solutions in the embodiments of the disclosure or in the prior art, the drawings to be used in the description of the embodiments or the prior art are introduced briefly below. Obviously, the drawings described below only relate to some embodiments in the disclosure, and those skilled in the art may achieve other drawings according to these drawings without paying inventive work.

FIG. 1 is a flow chart of a method for cleaning a substrate having an orientated film formed thereon according to the embodiments of the disclosure;

FIG. 2 is a flow chart of another method for cleaning a substrate having an orientated film formed thereon according to the embodiments of the disclosure.

### DETAILED DESCRIPTION

The technical solutions in the embodiments of the disclosure will be described clearly and detailedly below with the combination of the drawings in the embodiments of the disclosure. Obviously, the described embodiments only relate to a part, not all of the embodiments in the disclosure. Based on the embodiments in the disclosure, all of other embodiments achieved by those skilled in the art, without paying inventive work, belong to the protection scope of the disclosure.

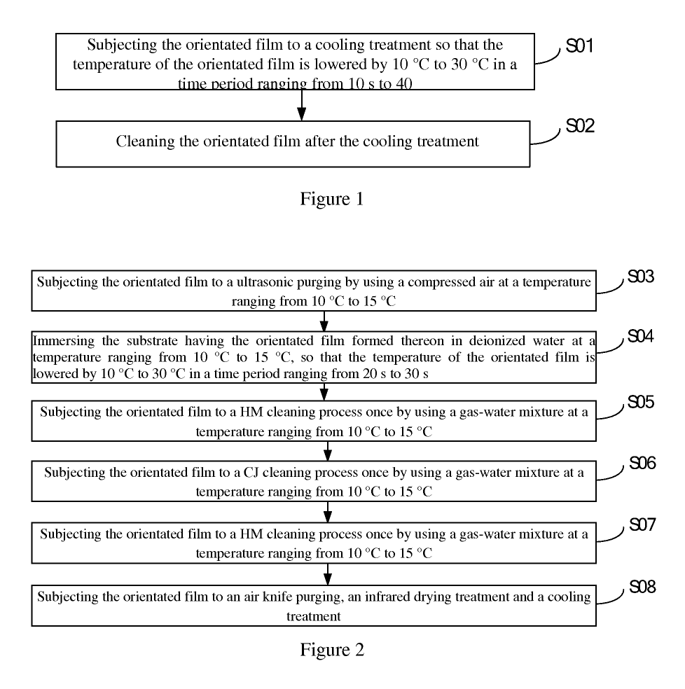

As shown in FIG. 1, the embodiments of the disclosure provide a method for cleaning a substrate having an orientated film formed thereon, comprising the steps of:

Step S01: subjecting the orientated film to a cooling treatment so that the temperature of the orientated film is lowered by 10° C. to 30° C. in a time period ranging from 10 s to 40 s.

In the above Step S01, there are many methods for subjecting the orientated film to a cooling treatment. Illustratively, the orientated film may be immersed in a solution at a lower temperature; the orientated film may be placed into an enclosed container at a lower environmental temperature; the orientated film may be purged by using a gas at a lower temperature; or the like. The embodiments of the disclosure do not specifically limit the cooling method as long as the temperature of the orientated film is lowered by 10° C. to 30° C. in a time period ranging from 10 s to 40 s.

By the way, “the temperature of the orientated film is lowered by 10° C. to 30° C.” means that the temperature of the orientated film is lowered from T1 to T2, and the difference between T1 and T2 is from 10° C. to 30° C. For example, the difference between T1 and T2 may be 15° C., 20° C., 25° C., or the like. Illustratively, in the case where the initial temperature of the orientated film is 40° C. and the temperature thereof after the cooling treatment is lowered to 25° C., the temperature of the orientated film is lowered by 15° C., which falls into the scope of 10° C. to 30° C.

Step S02: cleaning the orientated film after the cooling treatment.

In the above Step S02, there are many methods for cleaning the orientated film after the cooling treatment. Illustratively, the orientated film may be cleaned by using a solution; the orientated film may be purged by using a gas; or the like. The embodiments of the disclosure do not specifically limit the cleaning method. Additionally, the times for the cleaning are not limited in the embodiments of the disclosure. Illustratively, the orientated film after the cooling treatment may be cleaned for 2-4 times, depending upon the actual situations.

It should be noted that the cleaning method provided in the embodiments of the disclosure addresses to a substrate having an orientated film formed thereon, and there is no limitation on the type of the substrate. For example, the substrate may be an array substrate having a film layer of a thin film transistor, a pixel electrode, a passivation layer or the like formed thereon, and it may also be a color film substrate having a film layer of a black matrix or the like formed thereon.

According to the method for cleaning a substrate having an orientated film formed thereon provided in the embodiments of the disclosure, the temperature of the orientated film is lowered suddenly by 10° C. to 30° C. through the cooling treatment in a short time. The polarity and hardness of the rayon rubbing cloth remained on the orientated film and the polarity and hardness of the orientated film will be changed along with the sudden lowering of the temperature. Because the material for forming the rayon rubbing cloth is different from that of the orientated film, the changing rates of the polarity and hardness of the both along with the lowering of the temperature are different, and thus, the adhesion between the rayon rubbing cloth and the orientated film is reduced. Especially, when the difference between the changing rates of the polarity and hardness of the rayon rubbing cloth and that of the orientated film is prominent, the adhesion between the rayon rubbing cloth and the orientated film will be further reduced. Next, when the orientated film after the cooling treatment is further cleaned, the residual rayon rubbing cloth may be easily and completely removed, and thus, the orientation abnormality due to the residue of a rayon rubbing cloth on the orientated film is improved to the most extent, and furthermore, the occurrence probability of white Mura on a display panel is reduced.

There are many methods for subjecting the orientated film to a cooling treatment. Among others, two manners are specifically described in the embodiments of the disclosure.

According to the first manner, the orientated film is purged by using a gas at a temperature ranging from 5° C. to 15° C. so that the temperature of the orientated film is lowered by 10° C. to 30° C. It should be noted herein that the source and the type of the gas at a temperature ranging from 5° C. to 15° C. are not limited in the embodiments of the disclosure. Illustratively, the gas at a temperature ranging from 5° C. to 15° C. may be provided by a ultrasonic cleaning device. Of course, other manners may also be used, and the specific manner may be determined according to the actual situations. The gas may be air, nitrogen gas, or other gases comprising of a single element.

According to the second manner, the substrate having an orientated film formed thereon is immersed in a cleaning liquid at a temperature ranging from 5° C. to 15° C. so that the temperature of the orientated film is lowered by 10° C. to 30° C. The temperature of the cleaning liquid may be 8° C., 10° C., or 12° C. According to this cooling manner, the substrate is directly immersed in a cleaning liquid at a low temperature. As compare with the first manner, the heat conduction in the second manner is faster and thus, the time for lowering the temperature of the orientated film is shorter. At the same time, the orientated film may also be washed once by the cleaning liquid. This cooling manner is easy to be handled and controlled. According to the embodiments of the disclosure, the second manner is preferable, and on the basis of this, the embodiments of the disclosure are further described.

In the case where the second manner is used, that is, the orientated film is subjected to the cooling treatment by immersing the substrate having an orientated film formed thereon in a cleaning liquid at a temperature ranging from 5° C. to 15° C., the inventors found that in the actual cleaning process, the temperature of the cleaning liquid is generally 25° C. to 45° C., and specifically, the temperature of the cleaning liquid may reach 5° C. to 15° C. by adding ice into the cleaning liquid. Because low temperature may affect the connecting wires in other regions of the substrate or the film layers, the temperature of the cleaning liquid is controlled in the range of 10° C. to 15° C., so that various requirements may be satisfied and the effect thereof is superior. Optionally, the cleaning liquid may be deionized water or an organic solvent such as isopropanol or the like.

Furthermore, before the step of immersing the substrate having an orientated film formed thereon in a cleaning liquid at a temperature ranging from 5° C. to 15° C., the cleaning method further comprises a step of subjecting the orientated film to a ultrasonic cleaning. In this way, the orientated film is cleaned once before the orientated film is cooled, and thus, a part of the residual rayon rubbing cloth may be cleaned off, which may alleviate the subsequent cleaning work.

Furthermore, the step of subjecting the orientated film to a ultrasonic cleaning specifically comprises purging the orientated film by using a gas at a temperature ranging from 5° C. to 15° C., wherein the temperature of the gas may be 8° C., 10° C. or 12° C. In this way, by purging the low-temperature gas, not only a part of the residual rayon rubbing cloth may be cleaned off, but also the adhesion between the rayon rubbing cloth and the orientated film may be reduced, which facilitates the removing of the rayon rubbing cloth in the subsequent cleaning process.

Further preferably, the time for purging the orientated film using a gas at a temperature ranging from 5° C. to 15° C. may be 15 s to 30 s, wherein the purging time may be 18 s, 20 s, or 25 s. In this way, the following problems may be avoided: the desired effect cannot be achieved if the purging time is too short; and the performances of the substrate may be affected if this time is too long.

Optionally, the step of cleaning the orientated film after the cooling treatment specifically comprises using a gas-water mixture to clean the orientated film after the cooling treatment. The gas-water mixture refers to a mixture of a gas and water. Illustratively, the gas-water mixture may be a mixture of air and deionized water, and of course, it may be a mixture of another gas and deionized water, such as, a mixture of nitrogen gas and deionized water. Because air can be easily obtained with low cost, generally, air and deionized water are used to form a gas-water mixture. By cleaning the orientated film using the gas-water mixture, the rayon rubbing cloth is removed from the orientated film.

There are many manners for cleaning the orientated film by using a gas-water mixture. Illustratively, a high-pressure deionized water and a high-pressure air may be mixed, and a great deal of bubbles produced by such mixing are used to hit onto the orientated film, so that the residual substance is removed by the impact force produced from the breaking of the bubbles. This manner is referred to as CJ (Cavitation Jet) cleaning manner, by which 3-5 μm particles can be removed. Another manner which may be used comprises mixing and passing deionized water and air through a high-speed nozzle so that the liquid drops formed from the deionized water and air are ejected at a high speed, and when the liquid drops ejected from the nozzle are sprayed on the orientated film, the residual rubbing cloth adhered thereon will be dissolved and peeled off. This manner is referred to as HM (Hyper Mix) cleaning manner, by which 1-3 μm particles can be removed. Generally, in order to improve the cleaning effect, a supersonic nozzle is used to spray the liquid drops formed from deionized water and air at a supersonic speed.

It should be noted that the times of cleaning by using a gas-water mixture are not limited in the embodiments of the disclosure. Illustratively, the orientated film may be cleaned once by using a gas-water mixture, for example, the orientated film may be cleaned once in the HM manner; or the orientated film may be cleaned twice by using a gas-water mixture, for example, the orientated film may be cleaned once in the HM manner and once in the CJ manner; or the orientated film may be cleaned for three times by using a gas-water mixture, for example, the orientated film may be cleaned once in the HM manner, once in the CJ manner, and once in the HM manner. Preferably, the orientated film is cleaned for three times, and in this way, most of the rubbing cloth is completely removed.

Furthermore, the orientated film may be cleaned by using a gas-water mixture at a temperature ranging from 5° C. to 15° C., wherein the temperature of the gas-water mixture may be 8° C., 10° C., or 12° C. In this way, the adhesion between the rayon rubbing cloth and the orientated film is further reduced so that the residual rubbing cloth is removed at the most extent.

Optionally, after cleaning the orientated film after the cooling treatment, the cleaning method of the present disclosure further comprises subjecting the orientated film to an air knife purging, a drying treatment, a cooling treatment or the like in turn. The substrate having an orientated film formed thereon after the above processes is used for the subsequent processes.

The following process is used as a specific example for illustrating the cleaning method according to the embodiments of the disclosure, wherein an orientated film is subjected to a cooling treatment by immersing the substrate having the orientated film formed thereon in a cleaning liquid at a temperature ranging from 5° C. to 15° C.

As shown in FIG. 2, the cleaning method comprises the steps of:

Step S03: subjecting the orientated film to an ultrasonic purging by using a compressed air at a temperature ranging from 10° C. to 15° C.

Specifically, the time for purging the orientated film is 20 s.

Step S04: immersing the substrate having the orientated film formed thereon in deionized water at a temperature ranging from 10° C. to 15° C., so that the temperature of the orientated film is lowered by 10° C. to 30° C. in a time period ranging from 20 s to 30 s.

Specifically, the temperature of the deionized water may reach 10° C. to 15° C. by adding ice thereto.

Step S05: subjecting the orientated film to a HM cleaning process once by using a gas-water mixture at a temperature ranging from 10° C. to 15° C.

Step S06: subjecting the orientated film to a CJ cleaning process once by using a gas-water mixture at a temperature ranging from 10° C. to 15° C.

Step S07: subjecting the orientated film to a HM cleaning process once by using a gas-water mixture at a temperature ranging from 10° C. to 15° C.

It should be noted herein that in the HM cleaning processes of Step S07 and Step S05, the cleaning devices may be set by using the same parameters, such as pressure, power, cleaning time or the like. The cleaning devices may also be set by changing the corresponding parameters, for example, the parameters of pressure, power, cleaning time or the like may be adjusted slightly. The details may be determined depending upon the actual situations and are not limited in this disclosure.

Step S08: subjecting the orientated film to an air knife purging, an infrared drying treatment and a cooling treatment.

The testing results of many experiments proved that when the orientated film was subjected to cleaning at normal temperature without a cooling treatment, the incidence rate of white Mura in the display panel was 7%-9%; however, when the method provided by the above specific embodiments was used, the incidence rate of white Mura was reduced to about 0.9%.

The above contents are only the specific embodiments of the disclosure and the protection scope of the disclosure is not limited thereto. Any changes and replacements realizable by those skilled in the field based on the technology disclosed in the disclosure should be covered by the protection scope of the application. Thus, the protection scope of the application should be determined by the protection scope of the claims.

1. A method for cleaning a substrate having an orientated film formed thereon, comprising the steps of:
subjecting the orientated film to a cooling treatment, so that the temperature of the orientated film is lowered by 10° C. to 30° C. in a time period ranging from 10 seconds(s) to 40 s; and
cleaning the orientated film after the cooling treatment.

2. The method according to claim 1, wherein the step of subjecting the orientated film to the cooling treatment comprises immersing the substrate having the orientated film formed thereon in a cleaning liquid at a temperature ranging from 5° C. to 15° C.

3. The method according to claim 2, wherein the method further comprises, before the step of immersing the substrate having the orientated film formed thereon in the cleaning liquid at a temperature ranging from 5° C. to 15° C., a step of subjecting the orientated film to an ultrasonic cleaning.

4. The method according to claim 3, wherein the step of subjecting the orientated film to the ultrasonic cleaning comprises purging the orientated film using a gas at a temperature ranging from 5° C. to 15° C.

5. The method according to claim 4, wherein the time for purging the orientated film ranges from 15 s to 30 s.

6. The method according to claim 4, wherein the gas comprises a compressed air.

7. The method according to claim 2, wherein the cleaning liquid is deionized water or an organic solvent.

8. The method according to claim 7, wherein the cleaning liquid is isopropanol.

9. The method according to claim 1, wherein the step of subjecting the orientated film to the cooling treatment comprises purging the orientated film using a gas at a temperature ranging from 5° C. to 15° C.

10. The method according to claim 1, wherein the step of cleaning the orientated film after the cooling treatment comprises cleaning the orientated film after the cooling treatment using a gas-water mixture.

11. The method according to claim 10, wherein a temperature of the gas-water mixture ranges from 5° C. to 15° C.

12. The method according to claim 10, wherein the gas-water mixture is a mixture of air and deionized water.

13. The method according to claim 11, wherein the gas-water mixture is a mixture of air and deionized water.

14. The method according to claim 10, wherein a manner of cleaning the orientated film after the cooling treatment using the gas-water mixture comprises a cavitation jet manner and a hyper mix manner.

15. The method according to claim 1, wherein the method further comprises, after the step of cleaning the orientated film after the cooling treatment, subjecting the orientated film to a drying treatment.

16. The method according to claim 1, wherein the substrate comprises any one of an array substrate and a color film substrate used for a liquid crystal display.

17. The method according to claim 1, wherein the orientated film is formed by rubbing a transparent resin layer formed on a surface of the substrate.

18. The method according to claim 17, wherein the rubbing is performed by using a rubbing cloth.

19. The method according to claim 18, wherein the rubbing cloth is a rayon rubbing cloth.
